(19) United States
(12) Patent Application Publication
(10) Pub. No.: US 2025/0059001 A1
(43) Pub. Date: Feb. 20, 2025

(54) ELEVATOR SYSTEM AND METHOD FOR OPERATING

(71) Applicant: KONE Corporation, Helsinki (FI)

(72) Inventors: Ari KATTAINEN, Helsinki (FI); Tarvo VIITA-AHO, Helsinki (FI); Henri WENLIN, Helsinki (FI)

(73) Assignee: KONE Corporation, Helsinki (FI)

(21) Appl. No.: 18/936,674

(22) Filed: Nov. 4, 2024

Related U.S. Application Data
(63) Continuation of application No. PCT/EP2022/062437, filed on May 9, 2022.

(51) Int. Cl. B66B 5/00; B66B 5/18

(52) U.S. Cl. CPC B66B 5/0031; B66B 5/18

(57) ABSTRACT

An elevator system includes an elevator car, a hoisting machine moving the elevator car in a hoistway, and a hoisting machine brake having one or more brake pads moving into a brake position where the one or more brake pads contact a braking surface to reduce speed of the elevator car when activated to brake. To provide a solution ensuring reliable operation of the brake, the elevator system includes a temperature sensor providing a signal indicating a temperature of the braking surface, and a monitoring unit monitoring operation of the hoisting machine brake, the monitoring unit receiving the signal indicating the temperature and is configured to indicate a brake fault when the indicated temperature during an elevator run has reached an upper limit value or increased with more than a limit value.

### BACKGROUND OF THE INVENTION

### FIELD OF THE INVENTION

This invention relates to an elevator system and more particularly to a solution for ensuring reliable operation of brakes.

### DESCRIPTION OF PRIOR ART

Previously there is known an elevator with a hoisting machine moving an elevator car. In order to ensure that the elevator car can be stopped and held stationary when needed, the hoisting machine is provided with a hoisting machine brake. The hoisting machine brake has one or more brake pads contacting a brake surface to reduce the speed of the elevator car when activated to brake.

One challenge with the known elevator is to ensure that the hoisting machine brake works as intended. Preferably with a minimum of manual inspections to save costs. To achieve this, the previously known elevator is provided with a brake switch which changes state as the brake opens.

However, a problem with the known solution is that the brake switch does not always operate in a reliably way. For instance, when the brake is opened to allow movement of the elevator car, the brake pads may move sufficiently for the brake switch to change state though the brake has not opened completely. Due to this, the brake switch may be in a state indicating that the brake is released, though in reality, the brake pads still to some extent contact the brake surface due to which a braking force still occurs during elevator run.

Such an unwanted braking force is sometimes referred to as brake dragging, and it increases the risk of malfunctions in the brake.

### SUMMARY OF THE INVENTION

An object of the present invention is to solve the above-mentioned drawback and to provide a solution ensuring reliable operation of the brake. This object can be achieved with the elevator system according to independent claim 1 and the method of independent claim 11.

By utilizing a temperature sensor providing a signal indicating the temperature of the braking surface which during braking is in contact with the brake pad or pads of the brake, it becomes possible to rapidly and reliably obtain information about a brake fault of the brake, as specifically the temperature of brake surface will rapidly change if a braking force exists during an elevator run.

Preferred embodiments of the invention are disclosed in the dependent claims.

### BRIEF DESCRIPTION OF DRAWINGS

In the following the present invention will be described in closer detail by way of example and with reference to the attached drawings, in which

FIG. 1 illustrates a hoisting machine brake, and

FIG. 2 illustrates an elevator system.

### DESCRIPTION OF AT LEAST ONE EMBODIMENT

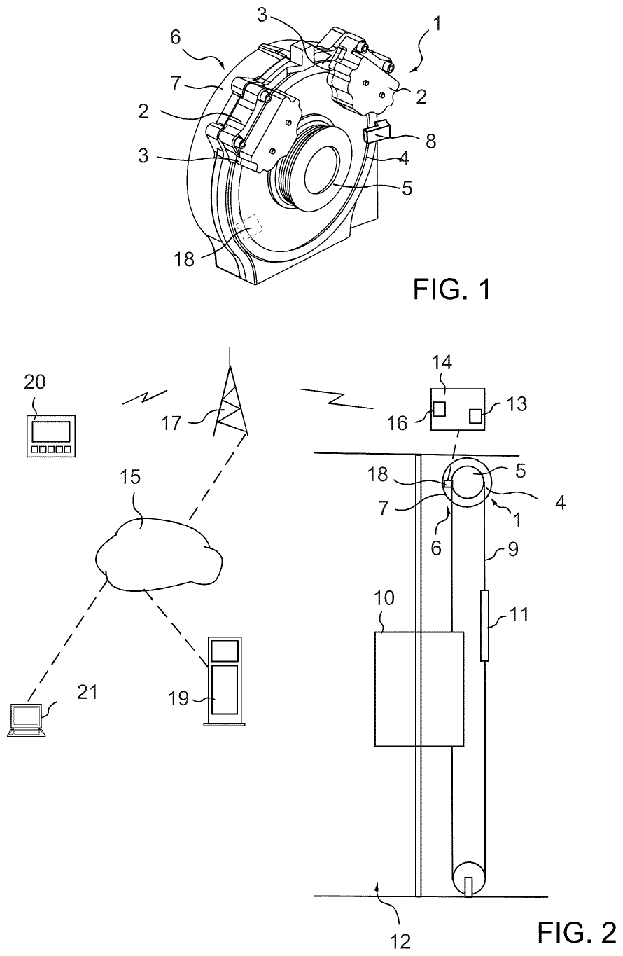

In the example of FIG. 1 the hoisting machine brake 1 is provided with a disc brake, though the invention may be utilized also in connection with other types of brakes.

The hoisting machine brake 1 comprises two brake units 2 with respective brake pads 3, which move into a brake position where the brake pads 3 contact a braking surface 4 to reduce speed of an elevator car when activated to brake. Additionally, the brake units may be utilized to keep the elevator car standstill. In this example, the braking surface is surface of a disk which rotates with a traction sheave 5 during elevator runs. The elevator car is suspended by a rope contacting the traction sheave 5, such that when the traction sheave 5 rotates, the rope and elevator car move in hoistway. Consequently, when the brake pads 3 contact the braking surface 4, the rotation speed of the braking surface 4 and the traction sheave is slowed down. It is possible that brake pads 3 are provided on both sides of the disk, in which case the disc has two braking surfaces.

In the example of FIG. 1, the hoisting machine brake 1 has been integrated with a hoisting machine 6, though this is not necessary in all implementations. The outer housing 7 of the hoisting machine 6 contains a stator of an electric motor included in the hoisting machine to rotate the traction sheave 5 during elevator runs. With such a solution the hoisting machine 6 and hoisting machine brake 1 can be implemented as a single compact device. However, alternatively it is possible that the electric motor of the hoisting machine is connected to the traction sheave with a relatively long axle, and that the hoisting machine brake is implemented as a separate component between the electric motor and the traction sheave. In that case, the outer surface of the axle may be used as the braking surface such that the braking pads contact directly the surface of the axle during braking. Alternatively, a brake disc can be attached to rotate with the axle, such that the surface of the brake disc works as the braking surface which is contacted by the brake pads during braking. Consequently, there exists several different solutions for implementing the hoisting machine brake with disk brakes or shoe brakes, for instance.

In order to ensure reliable operation of the elevator system, the hoisting machine brake 1 is provided with a temperature sensor 8, 18 providing a signal indicating a temperature of the braking surface 4. In FIG. 1 two alternative positions for such a temperature sensor have been illustrated. In many implementations it is, however, sufficient to have a temperature sensor provided at only one of the illustrated positions.

The first position for the temperature sensor 8 is on the front side of

the braking surface 4. In this connection the front side is the same side of the braking surface where the traction sheave 5 is located. A second possible position for the temperature sensor 18 is on the back side of the braking surface 4, in other words on the opposite side as compared to the traction sheave 5. In that case the temperature sensor 18 may be attached to a stator or the housing 7 of the hoisting machine 6 in FIG. 1.

In some implementations brake pads 3 may be provided only on one side of a disk with a brake surface 4, while the sensor 8, 18 is located on the opposite side of the disk as compared to the brake pads. Also in that case the sensor can provide a signal indicating the temperature of the braking surface, by measuring the temperature of the entire disk from the side of the sensor.

Irrespectively of where the temperature sensor 8, 18 is located, the temperature sensor is preferably implemented as a non-contact sensor, such as an infrared sensor directly facing the brake surface 4. In this way a more reliable temperature measurement can be obtained, as it is not necessary to attach the sensor directly to the parts which during braking generate heat and vibrate and where the stress over time on the sensor due to this would be significant. Instead, the sensor can be located at a small distance from these parts, which reduces the risk of malfunctions due to stress. Such non-contact sensor may be also retrofitted to an old elevator system without need of significant changes to the existing hoisting machine or the hoisting machine brake(s).

It is also advantageous that the sensor 8, 18 provides a signal indicating the temperature of specifically the brake surface 4, as the friction during braking directly increases the temperature of the brake surface. Therefore, changes in temperature indicating a possible malfunction of the brake can be most rapidly and reliably detected directly from the brake surface.

FIG. 2 illustrates an elevator system where a hoisting machine brake as explained in connection with FIG. 1 can be utilized, and in which the method according to the invention can be implemented.

FIG. 2 illustrates a rope 9 moving an elevator car 10 and a counterweight 11 in a hoistway 12. The hoisting machine 6 and the hoisting machine brake 1, irrespectively if they are implemented as one single part or as separate parts, are fixedly suspended in the hoistway 12. The rope 9 runs around the traction sheave 5.

A monitoring unit 13 monitors the operation of the hoisting machine brake 1 by receiving from the temperature sensor 18 the signal indicating the temperature of the brake surface. The monitoring unit 13 may be implemented with circuitry or with a combination of circuitry and software, such as with a processor running a program code stored in a memory. In the illustrated example it is by way of example assumed that the monitoring unit 13 is a part of an elevator control 14 controlling the operation of one or more elevator cars installed in a building, for instance.

The monitoring unit 13 is configured to indicate a brake fault in case the signal provided by the temperature sensor 8, 18 indicates that the temperature has reached an upper limit value or has increased with more than a limit value during an elevator run with the elevator car 10. One alternative is that the monitoring unit monitors the temperature in particular immediately or within a predefined time period after the elevator run has started, such as during an acceleration phase of the elevator car. At this stage the hoisting machine brake 1 should have been released so that practically no brake force remains.

However, in case of a malfunction, all brake 3 pads have possibly not moved a sufficient distance from the brake surface 4. If so, this will cause friction and the temperature of the brake surface 4 will raise during the elevator run. This raise of the temperature can be rapidly detected by the monitoring unit 13, and once the upper limit is reached or the temperature has raised more than the limit, a brake fault can be indicated.

The brake fault can be indicated locally by the monitoring unit 13 at the elevator installation site. However, in the illustrated example it is by way of example assumed that the monitoring unit 13 comprises an interface 16 provided by the elevator control 14 to a communication system 15.

5 In the example of FIG. 2 it is assumed that the interface 16 provides a connection to a base station 17 of a cellular communication system 15, in other words as a wireless interface, though in other implementations a wired solution is possible. Via this interface 16 a message indicating the brake fault can be sent to a predetermined receiver at a remote location. The term remote location 10 refers to another location than the installation site of the elevator car 10. The receiver may be implemented as a server computer 19 with a memory and running a software, which receives the brake fault indication and stores it in the memory for access by maintenance personnel. One alternative is also to utilize a cloud service which may be common to several elevators disposed in different 15 geographical locations. The stored fault indication may be accessed by maintenance personnel via wireless terminals 20 or wired terminals 21. Alternatively or additionally, the monitoring unit 13 may be configured to trigger transmission of a fault indication directly one or more terminals 20, 21.

When an indication of a brake fault has been made, the elevator control 14 of the elevator system may be configured to prevent further runs with the elevator car 10 in question. In that case further elevator runs may be allowed only after maintenance personnel has visited the installation site of the elevator car 10. Alternatively, the elevator control 14 may obtain temperature indications from the monitoring unit 13, and again allow the elevator car 10 in question to be used once the indicated temperature has returned to a permissible range, such as reached a lower limit value, as the hoisting machine brake has cooled down.

It is to be understood that the above description and the accompanying figures are only intended to illustrate the present invention. It will be obvious to a person skilled in the art that the invention can be varied and modified without departing from the scope of the invention.

1. An elevator system comprising:
an elevator car; a hoisting machine moving the elevator car in a hoistway;
a hoisting machine brake having one or more brake pads moving into a brake position where the one or more brake pads contact a braking surface to reduce speed of or hold standstill the elevator car when activated to brake;
a temperature sensor providing a signal indicating a temperature of the braking surface; and
a monitoring unit monitoring operation of the hoisting machine brake , the monitoring unit receiving the signal indicating the temperature and is configured to indicate a brake fault when the indicated temperature during an elevator run has reached an upper limit value or increased with more than a limit value.

2. The elevator system of claim 1, wherein the monitoring unit is configured to indicate the brake fault when the indicated temperature has reached the upper limit value or increased with more than the limit value immediately or within a predefined time period after the elevator run has started.

3. The elevator system of claim 1, wherein the temperature sensor is a non-contact sensor.

4. The elevator system of claim 1 wherein the temperature sensor is an infrared sensor.

5. The elevator system according to claim 1, wherein the temperature sensor is attached to a stationary part of the hoisting machine or the hoisting machine brake to provide an indication of the temperature of the braking surface rotating in relation to the stationary part during the elevator run.

6. The elevator system according to claim 1, wherein the temperature sensor is provided to a stator or housing of the hoisting machine .

7. The elevator system according to claim 1, wherein the monitoring unit comprises an interface (to a communication system and indicates the brake fault by sending a message via the communication system to a predetermined receiver.

8. The elevator system according to claim 1, wherein the elevator system is configured to prevent further elevator runs with the elevator car in response to an indication of a brake fault from the monitoring unit.

9. The elevator system according to claim 8, wherein the elevator system is configured to resume elevator operation when the indicated temperature has returned to a permissible range.

10. The elevator system according to claim 1, wherein the elevator system is configured to prevent further elevator runs with the elevator car in response to an indication of a brake fault from the monitoring unit until the indicated temperature has reached a lower limit value.

11. A method of operating an elevator, comprising the steps of:
obtaining a signal from a temperature sensor providing an indication of a temperature of a braking surface of a hoisting machine brake; and
detecting a brake fault when the indicated temperature has reached an upper limit value or increased with more than a limit value during an elevator run.

12. The method according to claim 11, further comprising the step of preventing use of the elevator until a signal obtained from the temperature sensor indicates that the temperature has reached a lower limit value.

13. The method according to claim 11, further comprising the step of sending a message indicating the brake fault via a communication system to a predetermined receiver.

14. The elevator system of claim 2, wherein the temperature sensor is a non-contact sensor.

15. The elevator system of claim 2 wherein the temperature sensor is an infrared sensor.

16. The elevator system according to claim 2, wherein the temperature sensor is attached to a stationary part of the hoisting machine or the hoisting machine brake to provide an indication of the temperature of the braking surface rotating in relation to the stationary part during the elevator run.

17. The elevator system according to claim 3, wherein the temperature sensor is attached to a stationary part of the hoisting machine or the hoisting machine brake to provide an indication of the temperature of the braking surface rotating in relation to the stationary part during the elevator run.

18. The elevator system according to claim 4, wherein the temperature sensor is attached to a stationary part of the hoisting machine or the hoisting machine brake to provide an indication of the temperature of the braking surface rotating in relation to the stationary part during the elevator run.

19. The elevator system according to claim 2, wherein the temperature sensor is provided to a stator or housing of the hoisting machine.

20. The elevator system according to claim 3, wherein the temperature sensor is provided to a stator or housing of the hoisting machine.
